(19) United States
(12) Patent Application Publication
(10) Pub. No.: US 2025/0157760 A1
(43) Pub. Date: May 15, 2025

(54) ARC CHUTE AND LOAD BREAK SWITCH COMPRISING SAME

(71) Applicant: LS ELECTRIC CO., LTD., Anyang-si, Gyeonggi-do (KR)

(72) Inventor: Sang Wook CHA, Anyang-si, Gyeonggi-do (KR)

(21) Appl. No.: 18/839,278

(22) PCT Filed: Feb. 2, 2023
(86) PCT No.: PCT/KR2023/001526

§ 371 Date: Aug. 16, 2024

(30) Foreign Application Priority Data
Feb. 24, 2022 (KR) 10-2022-0024233

(51) Int. Cl. H01H 33/08; H01H 33/12

(52) U.S. Cl. CPC H01H 33/08; H01H 33/121

(57) ABSTRACT

The present disclosure discloses an arc chute in which firing from the outside can be blocked and a load break switch including the same, the arc chute including: an arc grid part; two side cover parts spaced apart from each other and overlapping in one direction, and respectively coupled to both sides of the arc grid part; and a top cover part that is disposed between the two side cover parts and coupled to each of the two side cover parts, and is formed in a plate shape extending across both ends of the two side cover parts.

### CROSS-REFERENCE TO RELATED APPLICATIONS

This application is the National Stage filing under 35 U.S.C. 371 of International Application No. PCT/KR2023/001526, filed on Feb. 2, 2023, which claims the benefit of earlier filing date and right of priority to Korean Application No. 10-2022-0024233, filed on Feb. 24, 2022, the contents of which are all hereby incorporated by reference herein in their entirety.

### FIELD

The present disclosure relates to an arc chute and a load break switch including the same, and more particularly, to an arc chute in which firing from the outside can be blocked and a load break switch including the same.

### BACKGROUND

A load break switch (LBS) refers to a component that opens and closes the rated current of an electrical circuit to protect the branching and division of lines and the power system. Furthermore, in general power circuits where short-circuit protection is not required, load break switches can be used instead of circuit breakers to interrupt overload currents and ground fault currents.

A load break switch includes a fixed terminal part that is energizably connected to an external power source and a load, and a movable terminal part that can be moved toward or away from the fixed terminal part. The movable terminal part can be moved manually or automatically to contact and separate from the fixed terminal part.

When the movable terminal part comes into contact with the fixed terminal part, the load break switch is energized with an external power source and a load. That is, when the movable terminal part comes into contact with the fixed terminal part, the load break switch supplies power to the load.

Conversely, when the movable terminal part is separated from the fixed terminal part, the load break switch is disconnected from the external power source and the load, thereby cutting off the power supply to the load. In the above process, an arc is generated between the movable terminal part and the fixed terminal part.

Arc refers to an electrical discharge that occurs when a voltage is formed between two electrodes placed with a gas interposed therebetween and occurs when a gas existing between the two electrodes is converted into a conducting medium.

Since the arc is a high-temperature and high-pressure electron flow, it may delay blocking of current and cause damage to the load break switch. Therefore, rapid processing of the arc generated during the power cut-off process of the load break switch is required. This is called arc extinguishing. The load break switch includes an arc chute for arc extinguishing.

The arc chute is a component that extinguishes arcs that occur during the process of switching and interrupting current. The arc chute extends and cools the arc, thereby extinguishing the arc.

A typical arc chute is equipped with multiple arc grids. Each arc grid extends the arc length by directing the arc away from the fixed terminal part.

In this case, the flying debris and high-temperature gases accompanying the arc generation can be released to the outside through the gaps between the multiple arc grids. Since the arc voltage of the arc chute gradually decreases over time, the flying debris and high-temperature gases released to the outside may cause insulation breakdown and subsequent firing.

Therefore, the development of an arc chute capable of blocking firing from the outside and a load break switch including the same may be considered.

U.S. Pat. No. 9,653,237 discloses a switch having an arc chute. Specifically, it discloses a switch having an arc chute having a plurality of arc plates.

However, this type of arc chute can allow flying debris and high-temperature gases to pass between two adjacent arc plates, which can be released to the outside and cause insulation breakdown.

Korean Patent Registration No. 10-1977053 discloses an arc extinguishing device for a load break switch. Specifically, it discloses an arc extinguishing device of a load break switch which is a hybrid of a gas puffer extinguishing method using mechanically generated compressed gas and an arc chute extinguishing method using an electromagnetic field principle.

However, the arc chute equipped with this type of load break switch is partially exposed to the outside and communicates with the outside space, which may cause insulation breakdown and subsequent firing phenomenon by releasing flying debris and high-temperature gases to the outside.
(Patent Document 1) U.S. Pat. No. 9,653,237 (2017 Mar. 16)
(Patent Document 2) Korean Patent Registration No. 10-1977053 (2019 May 3)

### SUMMARY

The present disclosure is directed to providing an arc chute in which firing from the outside can be blocked, and a load break switch including the same.

The present disclosure is also directed to providing an arc chute in which the internal arc voltage can be kept constant, and a load break switch including the same.

The present disclosure is directed to providing an arc chute capable of further improving the arc cooling effect, and a load break switch including the same.

### Technical Solution

In order to achieve the above objects, an arc chute according to an aspect of the present disclosure includes an arc grid part: two side cover parts spaced apart from each other and overlapping in one direction, and respectively coupled to both sides of the arc grid part; and a top cover part that is disposed between the two side cover parts and coupled to each of the two side cover parts, and is formed in a plate shape extending across both ends of the two side cover parts.

In addition, the top cover part may have a top cover hole formed through a portion thereof.

In addition, the top cover part may include a plurality of top cover holes.

In addition, the top cover part may be formed to seal one side of the side cover part.

In addition, the top cover part may include a first top cover adjacent to the arc grid part; and a second top cover spaced apart from the first top cover and placed with the arc grid part and the first top cover interposed therebetween.

In addition, the first top cover may have a first top cover hole formed through a portion thereof.

In addition, the second top cover may have a second top cover hole formed through a portion thereof.

In addition, the first top cover hole and the second top cover hole may do not overlap each other in the arrangement direction of the first top cover and the second top cover.

In addition, the top cover part may be formed of a flat plate extending in one direction.

In addition, at least one side of the side cover part may be formed in a curved shape, and the top cover part may be formed of a curved plate corresponding to the curve of the side cover part.

In addition, at least a portion of the top cover part may be formed of an N-9 (nylon-9) material.

In addition, one surface of the top cover part facing the arc grid part may be formed of an N-9 material.

In addition, the arc grid part may have a grid hole formed through a portion thereof.

In addition, the arc grid part may be formed by alternately arranging two arc grids in which the grid holes are formed at different parts.

In addition, the present disclosure provides a load break switch, including a switch unit comprising a fixed terminal part and a movable terminal part: a frame unit accommodating a portion of the fixed terminal part: a rotation shaft rotatably coupled to the frame unit and connected to the movable terminal part to rotate together with the movable terminal part; and an arc chute placed adjacent to the fixed terminal part, wherein the arc chute include an arc grid part: two side cover parts spaced apart from each other, overlapping in one direction, respectively coupled to both sides of the arc grid part, and respectively coupled to an outer circumferential surface of the frame unit; and a top cover part that is disposed between the two side cover parts, coupled to each of the two side cover parts, spaced apart from the outer circumferential surface of the frame unit, and is formed in a plate shape extending across both ends of the two side cover parts.

In addition, the top cover part may have a top cover hole formed at a position which is biased toward the fixed terminal part adjacent with respect to the central portion.

In addition, the arc chute may include an arc runner placed between the two side cover parts, coupled to the two side cover parts, respectively, placed between the fixed terminal part and the arc grid part, with a portion thereof in contact with the fixed terminal part.

In addition, the top cover part may include a first top cover adjacent to the arc grid part; and a second top cover spaced apart from the first top cover and positioned radially outward of the frame unit with respect to the first top cover.

In addition, the first top cover may have a first top cover hole formed at a position which is biased toward the fixed terminal part adjacent with respect to the central portion.

In addition, the top cover part may be formed of a flat plate extending in one direction.

Among the various effects of the present disclosure, the effects that can be obtained through the above-described solution are as follows.

First, the arc chute includes two side cover parts coupled to both sides of the arc grid part, respectively, and a top cover part placed between the two side cover parts. In this case, the top cover part is formed in a plate shape crossing both ends of the two side cover parts.

Therefore, the discharge of flying debris and high-temperature gas generated during arc generation can be blocked by the top cover part. Accordingly, insulation breakdown due to the flying debris and high-temperature gas discharged to the outside of the arc chute can be prevented. As a result, firing outside the arc chute can be blocked.

In addition, one side of the space between two adjacent arc grid parts is blocked by the top cover part.

Therefore, the arc voltage inside the arc chute can be kept constant regardless of the lapse of time. Furthermore, the arc extinguishing performance of the arc chute can be further improved.

In addition, one surface of the first top cover part facing the arc grid part is formed of an N-9 (nylon-9) material. The N-9 material is directly exposed to the arc and emits hydrogen gas with excellent thermal conductivity.

Therefore, the top cover part generates hydrogen gas when directly exposed to the arc and can increase the arc extinguishing cooling effect.

### BRIEF DESCRIPTION OF THE DRAWINGS

FIG. 1 is a perspective view illustrating a load break switch according to an exemplary embodiment of the present disclosure.

FIG. 2 is a perspective view illustrating a frame unit provided in the load break switch of FIG. 1.

FIG. 3 is a front view illustrating the frame unit of FIG. 2.

FIG. 4 is a front cross-sectional view illustrating the load break switch of FIG. 1.

FIG. 5 is a front view illustrating a rotation shaft, puffer guide, and arc chute provided in the load break switch of FIG. 1.

FIG. 6 is a side view illustrating the puffer guide and arc chute of FIG. 5.

FIG. 7 is a perspective view illustrating the arc chute provided in the load break switch of FIG. 1.

FIG. 8 is a front view illustrating the arc chute of FIG. 7.

FIG. 9 is a side view illustrating the arc chute of FIG. 7.

FIG. 10 is a perspective view illustrating a fastening part provided in the arc chute of FIG. 7.

FIG. 11 is an exploded perspective view illustrating an arc runner and arc grid part provided in the arc chute of FIG. 7.

FIG. 12 is a conceptual view illustrating the arc runner and arc grid part provided in the arc chute of FIG. 7.

FIG. 13 is a side view illustrating a first arc grid provided in the arc grid part of FIGS. 11 and 12.

FIG. 14 is a side view illustrating a second arc grid provided in the arc grid part of FIGS. 11 and 12.

FIG. 15 is a perspective view illustrating a top cover part provided in the arc chute of FIG. 7.

FIG. 16 is a perspective view illustrating a top cover part according to an exemplary embodiment different from that of FIG. 15.

FIG. 17 is a perspective view illustrating an arc chute according to an exemplary embodiment different from that of FIG. 7.

FIG. 18 is a front view illustrating the arc chute of FIG. 17.

FIG. 19 is a perspective view illustrating a top cover part provided in the arc chute of FIG. 17.

FIG. 20 is a perspective view illustrating a top cover part according to an exemplary embodiment different from that of FIG. 17.

FIG. 21 is a conceptual view illustrating a state before and after arc generation of an arc chute according to an exemplary embodiment of the present disclosure.

### DETAILED DESCRIPTION

Hereinafter, an arc chute 60 and a load break switch 1 including the same according to an exemplary embodiment of the present disclosure will be described in more detail with reference to the drawings.

In the following description, in order to clarify the features of the present disclosure, descriptions of some components may be omitted.

In this specification, even in different embodiments, the same reference numerals will designate the same elements, and a redundant description thereof will be omitted.

The accompanying drawings are only for easy understanding of the embodiments disclosed herein, and the technical ideas disclosed herein are not limited by the accompanying drawings.

Expressions in the singular include plural expressions unless the context clearly indicates otherwise.

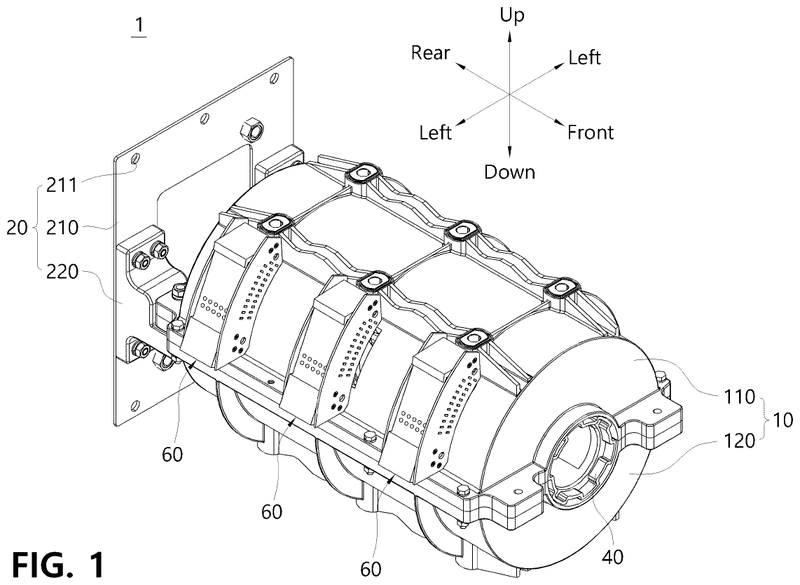

The terms “upward”, “upper side”, “above”, “downward”, “lower side”, “below”, “left side”, “right side”, “front side”, “frontward” “rear side”, “rearward” used in the following description will be understood with reference to the coordinate system shown in FIGS. 1, 7, 15, 16, 17, 19, and 20.

Description of the load break switch 1 according to an exemplary embodiment of the present disclosure

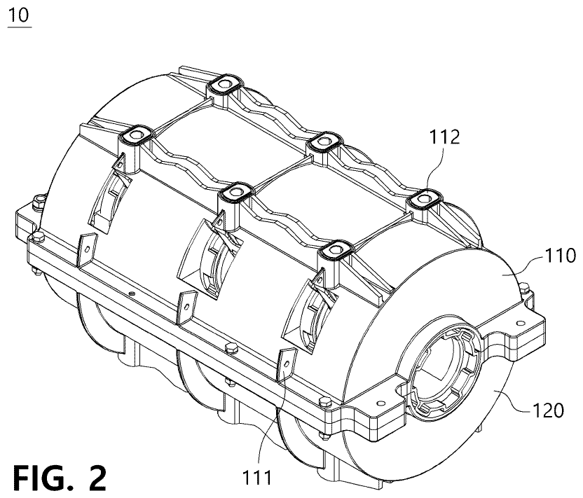

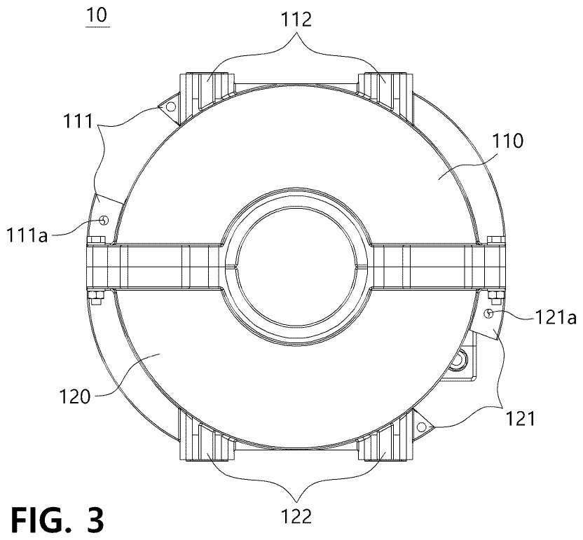

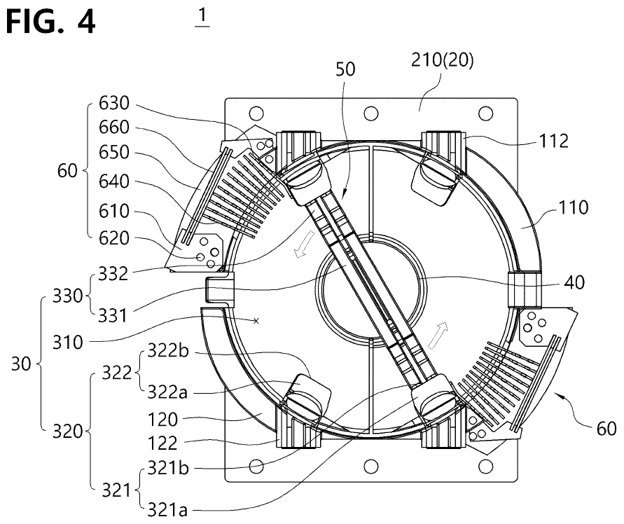

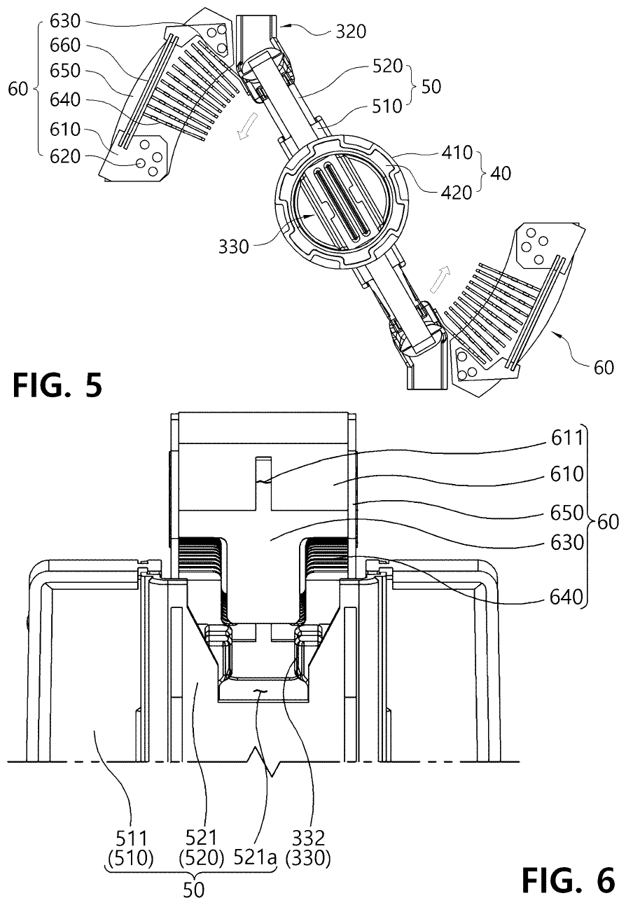

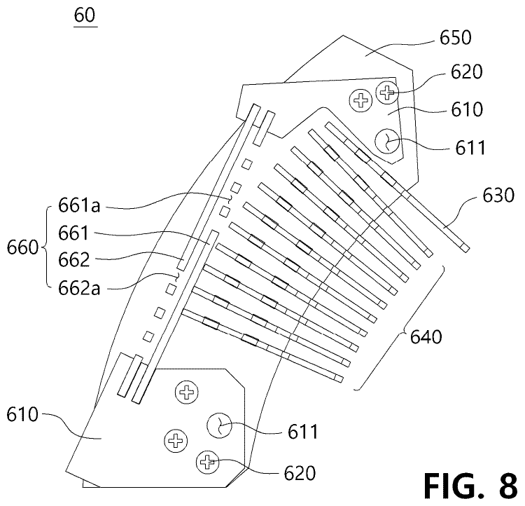

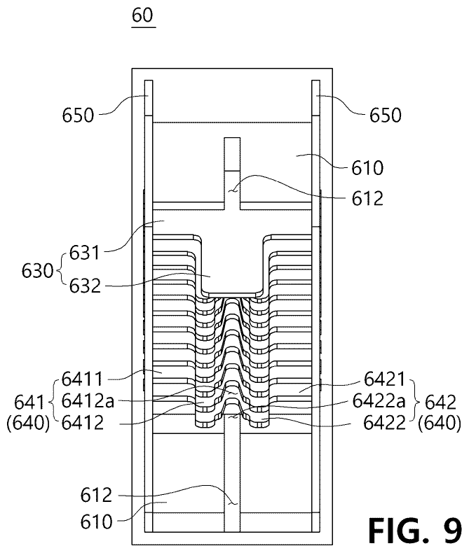

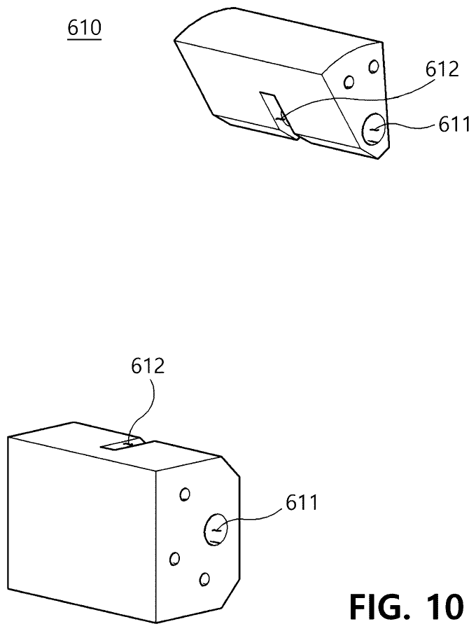

Hereinafter, the load break switch 1 according to an exemplary embodiment of the present disclosure will be described with reference to FIGS. 1 to 16. However, the direction of rotation of each component will be understood with reference to FIGS. 4 and 5.

The load break switch 1 may switch on and off the rated current of the electrical circuit. That is, the load break switch 1 may allow or block energization state between an external power source and a load. To this end, the load break switch 1 is energizably connected to an external power source and a load. In other words, the external power source and the load are energizably connected by the load break switch 1.

When a fixed contact 321b, 322b and a movable contact 332 of the load break switch 1 come into contact with each other, an external power source and a load may be energizably connected through the load break switch 1. Conversely, when the fixed contact 321b, 322b and the movable contact 332 of the load break switch 1 are separated from each other, the energization state between the external power source and the load is cut off.

The switching on/off of the load break switch 1 may be operated manually or automatically. To this end, a separate operation unit may be coupled to the load break switch 1.

Hereinafter, the configuration of the load break switch 1 according to an exemplary embodiment of the present disclosure will be described with reference to the attached drawings, but a frame unit 10, a fixing part 20, a switch unit 30, a rotation shaft 40, a puffer guide 50, and an arc chute 60 will be described in separate sections.

### Description of the Configuration of the Load Break Switch 1

The load break switch 1 may be energizably connected to an external power source and a load, respectively, to allow or block energization state between the power source and the load. Specifically, the load break switch 1 has a fixed terminal part 320 and a movable terminal part 330 that come into contact with or are separated from each other, and allows or blocks energization state between an external power source and a load.

In an embodiment, the load break switch 1 is coupled to a handle. The user may manually operate the handle whether to switch the load break switch 1 on/off. In the case of a load break switch 1 equipped in a ring main unit (RMU), the switching on/off may be controlled by rotating the handle.

In another embodiment, an operation unit is attached to the load break switch 1. The operation unit switches on or off the electrical circuit between an external power source and a load under certain conditions. That is, whether to switch on/off the load break switch 1 may be automatically controlled by the operation unit.

In the illustrated embodiment, the load break switch 1 includes a frame unit 10, a fixing part 20, a switch unit 30, a rotation shaft 40, a puffer guide 50, and an arc chute 60.

Hereinafter, the configuration of the load break switch 1 is described in more detail with reference to the attached drawings.

### (2) Description of the Frame Unit 10 and Fixing Part 20

Hereinafter, the frame unit 10 will be described with reference to FIGS. 1 to 3.

The frame unit 10 forms the exterior of the load break switch 1.

The outer circumference of the frame unit 10 is formed in a shape corresponding to the arc chute 60. In the illustrated embodiment, the frame unit 10 is formed in a cylindrical shape. However, the shape of the frame unit 10 is not limited to the illustrated embodiment, and may be formed in various structures capable of accommodating various devices therein.

A through hole capable of accommodating the fixed terminal part 320 is formed on the outer circumference of the frame unit 10. In the illustrated embodiment, the upper and lower outer circumferential surfaces of the frame unit 10 are formed with through holes in the up-down direction to accommodate the fixed terminal part 320.

The frame unit 10 has a space formed therein to accommodate various devices. Various devices performing a function of applying or blocking electric current transferred from the outside by the load break switch 1 may be accommodated in the space. In the illustrated embodiment, the switch unit 30, the rotation shaft 40, and the puffer guide 50 are accommodated in the space.

The rotation shaft 40 coupled to the puffer guide 50 is through-coupled to the frame unit 10. In the illustrated embodiment, the rotation shaft 40 is through-coupled to the central portion of the frame unit 10 in the front-rear direction. Specifically, the rotation shaft 40 is positioned in a straight line with the central axis of the frame unit 10.

The gas inside the frame unit 10 may be compressed instantaneously by the pressure generated when the rotation shaft 40 rotates. The gas passes through the puffer guide 50 and moves in the opposite direction. In the above process, the gas may pass through the puffer guide 50 at high speed. As a result, the arc generated during the switching on/off process can be extinguished through the above process.

The fixing part 20 and the arc chute 60 are fixed and connected to the outside of the frame unit 10. In the illustrated embodiment, the fixing part 20 is coupled to the rear side of the frame unit 10, and the arc chute 60 is coupled to the outer circumference of the frame unit 10.

In an embodiment, the frame unit 10 may be formed of an insulating material. For example, the frame unit 10 may be formed of a synthetic resin material. Thus, the inside and outside of the frame unit 10 can be prevented from being arbitrarily energized. That is, the arc, which is a flow of electrons, can be prevented from randomly leaking out of the frame unit 10.

In another embodiment, the frame unit 10 may be formed of a material having high pressure resistance and high heat resistance. Thus, burnout to the frame unit 10 caused by an arc, which is a high-temperature and high-pressure electron flow, can be prevented.

In the illustrated embodiment, the frame unit 10 includes an upper frame 110 and a lower frame 120.

The upper frame 110 forms the upper exterior of the load break switch 1.

The upper frame 110 is formed in a semi-cylindrical shape. Specifically, the upper frame 110 has a semi-cylindrical shape with a curved surface portion facing upward. In this case, the outer circumference of the upper frame 110 is formed in a shape corresponding to the arc chute 60.

The arc chute 60 is closely coupled to the outer circumferential surface of the upper frame 110. To this end, an upper fastening wing part 111 may be formed on the outer circumference of the upper frame 110. That is, the upper fastening wing part 111 is closely coupled to the arc chute 60.

The upper fastening wing part 111 is disposed adjacent to the arc chute 60 and is inserted into and coupled to the arc chute 60.

The upper fastening wing part 111 is formed in a plate shape. The upper fastening wing part 111 is formed to extend from a circular arc limited by any two points on the outer circumferential surface of the upper frame 110 toward the radially outer side of the upper frame 110. That is, the upper fastening wing part 111 is formed to protrude radially outward of the frame unit 10 from the outer circumferential surface of the upper frame 110.

In an embodiment, the upper fastening wing part 111 may be formed in a shape corresponding to a fastening groove 612 of the arc chute 60 to be described later.

An upper fastening wing hole 111a is formed in the upper fastening wing part 111.

The upper fastening wing hole 111a functions as a passage for a coupling member 620 of the arc chute 60. The coupling member 620 of the arc chute 60 passes through the upper fastening wing hole 111a and is coupled to the upper fastening wing part 111. That is, the coupling member 620 of the arc chute 60 is through-coupled to the upper fastening wing hole 111a. In an embodiment, the coupling may be a bolt coupling method.

The upper fastening wing hole 111a may be formed by extending a predetermined cross-section in one direction. In this case, the predetermined cross-section may be changed according to the coupling member 620 of the arc chute 60. In the illustrated embodiment, the upper fastening wing hole 111a is formed by extending a circular cross-section in the front-rear direction.

In addition, an upper fixed terminal accommodation part 112 that can accommodate the fixed terminal part 320 is formed to protrude from the outer circumference of the upper frame 110.

The upper fixed terminal accommodation part 112 accommodates the fixed terminal part 320 so that the fixed terminal part 320 communicates with the external and internal spaces of the frame unit 10.

A space for accommodating the fixed terminal part 320 is formed inside the upper fixed terminal accommodation part 112. Specifically, a fixed contact terminal is accommodated in the space. That is, the fixed contact terminal is through-coupled to the upper fixed terminal accommodation part 112.

The upper fixed terminal accommodation part 112 is formed in a pillar shape with a hollow formed therein. In the illustrated embodiment, the upper fixed terminal accommodation part 112 extends upward from the upper outer circumferential surface of the upper frame 110.

The upper fixed terminal accommodation part 112 is disposed to surround the fixed terminal part 320. That is, the fixed terminal part 320 is surrounded by the upper fixed terminal accommodation part 112.

A plurality of upper fixed terminal accommodation part 112 may be provided. The number of upper fixed terminal accommodation parts 112 is the same as the number of fixed terminal parts 320 coupled to the upper frame 110. In the illustrated embodiment, three pairs of upper fixed terminal accommodation parts 112 are arranged side by side in the front-rear direction.

The number of the upper fixed terminal accommodation parts 112 may be determined according to the type of power system provided with the load break switch 1 of the present disclosure. In an embodiment, the load break switch 1 is provided in a power system using a three-phase circuit of R, S, and T phases. Accordingly, three pairs of upper fixed terminal accommodation parts 112 are also provided in accordance with the three-phase circuit.

A lower frame 120 is coupled to the lower side of the upper frame 110.

The lower frame 120 forms the lower exterior of the load break switch 1.

The lower frame 120 disposed adjacent to the upper frame 110. In addition, the lower frame 120 is disposed below the upper frame 110.

The lower frame 120 is symmetrical to the upper frame 110 with respect to the rotation shaft 40. In the illustrated embodiment, the upper frame 110 and the lower frame 120 are arranged to be up-down symmetrical with respect to the rotation shaft 40.

The lower frame 120 is formed in a semi-cylindrical shape. Specifically, the lower frame 120 has a semi-cylindrical shape with a curved surface portion facing downward. In this case, the outer circumference of the lower frame 120 is formed in a shape corresponding to the arc chute 60.

The upper end of the lower frame 120 is in contact with the lower end of the upper frame 110. In addition, the upper end of the lower frame 120 is formed in a shape corresponding to the lower end of the upper frame 110.

The arc chute 60 is closely coupled to the outer circumferential surface of the lower frame 120. To this end, a lower fastening wing part 121 may be formed on the outer circumference of the lower frame 120. That is, the lower fastening wing part 121 is closely coupled to the arc chute 60.

A lower fastening wing hole 121a is formed in the lower fastening wing part 121.

The lower fastening wing part 121 and the lower fastening wing hole 121a correspond in function and structure to the upper fastening wing part 111 and the upper fastening wing hole 111a of the upper frame 110, respectively. Therefore, overlapping descriptions thereof will be omitted.

In addition, a lower fixed terminal accommodation part 122 that can accommodate the fixed terminal part 320 is formed to protrude from the outer circumference of the lower frame 120. In the illustrated embodiment, the lower fixed terminal accommodation part 122 extends downward from the lower outer circumferential surface of the lower frame 120.

The lower fixed terminal accommodation part 122 corresponds in function and structure to the upper fixed terminal accommodation part 112 of the upper frame 110. Therefore, overlapping descriptions thereof will be omitted.

The fixing part 20 firmly installs the frame unit 10 to the main body of the ring main unit, distribution board, etc.

The fixing part 20 is disposed adjacent to the frame unit 10. In the illustrated embodiment, the fixing part 20 is disposed at the rear side of the frame unit 10.

The fixing part 20 is disposed between the frame unit 10 and a specific member (not shown) in which the load break switch 1 is installed, and is coupled to the frame unit 10 and the specific member, respectively. That is, the frame unit 10 and the specific member may be coupled by the fixing part 20.

Therefore, the load break switch 1 may be operated in a state in which the frame unit 10 is coupled to the specific member without separated from the specific member.

The fixing part 20 may be formed of a highly rigid material. For example, the fixing part 20 may be formed of a metal material. Therefore, damage to the fixing part 20 and separation of the frame unit 10 due to an external impact may be prevented.

In the illustrated embodiment, the fixing part 20 includes a fixing plate 210 and a support fixture 220.

The fixing plate 210 is a member to which the fixing part 20 is directly coupled to the specific member.

The fixing plate 210 is formed on one side of the fixing part 20 opposite to the frame unit 10. In the illustrated embodiment, the fixing part 210 is formed on the rear side of the fixing plate.

The fixing plate 210 is formed in a plate shape. In an embodiment, a through hole may be formed in the central portion of the fixing plate 210. Therefore, the fixing plate 210 may be lighter.

In the illustrated embodiment, the fixing plate 210 is formed in a quadrangular plate shape having a through hole formed in the central portion thereof. In the above embodiment, the central point of the fixing plate 210 is positioned on an extension line of the center line of the frame unit 10.

A fixing hole 211 may be formed through the fixing plate 210.

In an embodiment, a member for coupling the specific member and the fixing plate 210 may be through-coupled to the fixing hole 211. In this case, it is preferable that a through hole communicating with the fixing hole 211 is formed in the specific member.

A support fixture 220 is disposed between the fixing plate 210 and the frame unit 10.

The support fixture 220 is disposed between the fixing plate 210 and the frame unit 10, and is coupled to the fixing plate and the frame unit 10, respectively. That is, the fixing plate and the frame unit 10 may be coupled to each other through the support fixture 220. Therefore, the frame unit 10 may be spaced apart from the fixing plate 210.

The support fixture 220 is coupled to one surface of the fixing plate 210 facing the frame unit 10. In addition, the support fixture 220 is coupled to one side of the frame unit 10 facing the support fixture 220. The coupling may be a bolt coupling method.

The support fixture 220 extends in a direction toward the frame unit 10 and the fixing plate 210. In the illustrated embodiment, the support fixture 220 extends in the front-rear direction.

In an embodiment, a plurality of support fixtures 220 may be provided. In the above embodiment, the plurality of support fixtures 220 are arranged such that their central points are the same as the central point of the fixing plate 210.

### (3) Description of the Switch Unit 30

Hereinafter, the switch unit 30 will be described with reference to FIGS. 4 to 6.

The switch unit 30 is accommodated in the inner space of the frame unit 10 to allow or block the electric current energization. Specifically, the switch unit 30 allows the electric current energization by bringing the fixed contact 321b, 322b and the movable contact 332 into contact, or blocks the electric current energization by bringing the fixed contact 321b, 322b and the movable contact 332 apart.

A plurality of switch units 30 may be provided. In the illustrated embodiment, three switch units 30 are arranged side by side in the front-rear direction.

The number of the switch units 30 may be determined according to the type of power system provided with the load break switch 1 of the present disclosure. When the load break switch 1 is provided in a power system using a three-phase circuit of R, S, and T phases, three switch units 30 may also be provided in accordance with the three-phase circuit.

In the illustrated embodiment, the switch unit 30 includes an arc chamber 310, a fixed terminal part 320, and a movable terminal part 330.

The arc chamber 310 may also be referred to as an “arc extinguishing unit”. The arc chamber 310 extinguishes an arc generated when the fixed contact 321b, 322b and the movable contact 332 are spaced apart from each other. Specifically, the arc chamber 310 forms a space capable of extinguishing an arc therein.

The gas inside the space may be compressed instantaneously by the pressure generated when the movable terminal part 330 moves. In this case, the gas may flow in a direction opposite to the rotation direction while passing through the puffer guide 50. In the above process, the gas flows through the puffer guide 50 at high speed, and an arc extinguishing operation may be performed.

The arc chamber 310 hermetically accommodates the fixed terminal part 320 and the movable terminal part 330. That is, the fixed terminal part 320 and the movable terminal part 330 are accommodated inside the arc chamber 310. Therefore, the arc generated by the separation of the fixed contact 321b, 322b and the movable contact 332 is not arbitrarily discharged to the outside of the arc chamber 310.

The fixed terminal part 320 is energizably connected to an external power source or a load. Through the fixed terminal part 320, the load break switch 1 may be energizably connected to an external power source or a load.

A portion of the fixed terminal part 320 is accommodated inside the arc chamber 310.

The fixed terminal part 320 may be formed of a conductive material. For example, the fixed terminal part 320 may be formed of copper (Cu), silver (Ag), or the like.

In addition, a portion of the fixed terminal part 320 is accommodated in the internal space of the frame unit 10, so that energization between the inside and outside of the load break switch 1 can be applied or blocked. Specifically, the fixed terminal part 320 is in contact with or spaced apart from the movable terminal part 330 to apply or block energization between the inside and outside of the load break switch 1.

The fixed terminal part 320 is coupled to the fixed terminal accommodation part 112, 122 of the frame unit 10. The fixed terminal part 320 is surrounded by the fixed terminal accommodation part 112, 122 and seals the fixed terminal accommodation part 112, 122. That is, the movement of the material through the fixed terminal accommodation part 112, 122 is blocked by the fixed terminal part 320.

The fixed terminal part 320 is not moved in the internal space of the frame unit 10. Thus, the contact and separation of the fixed terminal part 320 and the movable terminal part 330 are achieved by the movement of the movable terminal part 330.

The remaining portion of the fixed terminal part 320 except for the above portion is exposed to the outside of the frame unit 10. The remaining portion may be energizably connected to an external power source or a load by a conducting wire member (not shown) or the like.

A plurality of fixed terminal parts 320 may be provided. The number of fixed terminal parts 320 is the same as the number of fixed terminal accommodation parts 112, 122 provided in the frame unit 10.

In the illustrated embodiment, four fixed terminal parts 320 are formed as one group, and three groups of fixed terminal parts 320 are arranged side by side in the front-rear direction. In the above embodiment, the two fixed terminal parts 320 facing each other with the rotation shaft 40 interposed between them are arranged to be point-symmetric with respect to the central axis of the rotation shaft 40.

The two fixed terminal parts 320 facing each other with the rotation shaft 40 interposed therebetween may be energizably connected to each other. The connection is formed by contacting the movable terminal part 330 with the two fixed terminal parts 320, respectively.

In the illustrated embodiment, the fixed terminal part 320 includes a first fixed terminal part 321 and a second fixed terminal part 322.

The first fixed terminal part 321 is energizably connected to an external power source and a load, or energizably connected to a ground wire. The second fixed terminal part 322 is energizably connected to a ground wire, or energizably connected to an external power source and a load.

The movable terminal part 330 may be moved and may be in contact with or spaced apart from the first fixed terminal part 321 or the second fixed terminal part 322. However, the movable terminal part 330 cannot simultaneously contact the first fixed terminal part 321 and the second fixed terminal part 322, and may contact only one of the first fixed terminal part 321 and the second fixed terminal part 322.

Specifically, the movable terminal part 330 may be rotated in a direction toward the fixed terminal part 320 or away from the fixed terminal part 320.

When the movable terminal part 330 rotates in a direction away from the fixed terminal part 320, the movable terminal part 330 and the fixed terminal part 320 are separated from each other, and an arc is generated between the movable terminal part 330 and the fixed terminal part 320.

In an embodiment, the first fixed terminal part 321 may be energizably connected to an external power source and a load, and the second fixed terminal part 322 may be energizably connected to a ground wire.

In the above embodiment, when the movable terminal part 330 contacts the first fixed terminal part 321, energization between an external power source and a load may be applied. In addition, when the movable terminal part 330 contacts the second fixed terminal part 322, the movable terminal part 330 is energizably connected to the ground wire, and energization between the external power source and the load is cut off.

When the movable terminal part 330 is spaced apart from both the first fixed terminal part 321 and the second fixed terminal part 322, electric current outside the load break switch 1 is not transmitted to the inside of the load break switch 1.

In the illustrated embodiment, the first fixed terminal part 321 includes a first fixed contact terminal 321a and a first fixed contact 321b.

The first fixed contact terminal 321a is energizably connected to an external power source or a load.

A portion of the first fixed contact terminal 321a is accommodated in the inner space of the frame unit 10, and the remaining portion is exposed to the outside of the frame unit 10. Specifically, a portion of the first fixed contact terminal 321a is surrounded by the fixed terminal accommodation part 112, 122.

A plurality of first fixed contact terminals 321a may be provided. In the illustrated embodiment, a total of twelve first fixed contact terminals 321a are provided, six on the upper side and six on the lower side of the frame unit 10.

In an embodiment, the first fixed contact terminal 321a may have a cylindrical shape bent and extending in a direction toward the rotation shaft 40.

The first fixed contact 321b is formed at one end of the first fixed contact terminal 321a facing the rotation shaft 40.

The first fixed contact 321b is disposed adjacent to the first fixed contact terminal 321a. In addition, the first fixed contact 321b is energizably connected to the first fixed contact terminal 321a.

The first fixed contact 321b may be in contact with or spaced apart from the movable contact 332. Accordingly, the load break switch 1 may be energized or cut off from an external power source or a load.

In an embodiment, the first fixed contact 321b may be integrally formed with the first fixed contact terminal 321a.

The second fixed terminal part 322 is disposed to be spaced apart from the first fixed terminal part 321.

The second fixed terminal part 322 is energizably connected to a member that is not connected to the first fixed terminal part 321 among an external power source, a load, and a ground wire. That is, when the first fixed terminal part 321 is energizably connected to an external power source and a load, the second fixed terminal part 322 is energizably connected to a ground wire.

In the illustrated embodiment, the second fixed terminal part 322 includes a second fixed contact terminal 322a and a second fixed contact 322b.

The second fixed contact terminal 322a and the second fixed contact 322b correspond in function and structure to the first fixed contact terminal 321a and the first fixed contact 321b. Therefore, overlapping descriptions thereof will be omitted.

The movable terminal part 330 is energizably connected to or separated from the fixed terminal part 320. Through the movable terminal part 330, a plurality of fixed terminal parts 320 may be energizably connected to each other. As a result, the load break switch 1 can be energizably connected to an external power source or a load.

The movable terminal part 330 is accommodated in the inner space of the frame unit 10. The movable terminal part 330 is rotatably coupled to the internal space of the frame unit 10.

The movable terminal part 330 is coupled to the rotation shaft 40. When the rotation shaft 40 is rotated, the movable terminal part 330 may also be rotated together with the rotation shaft 40.

In addition, a portion of the movable terminal part 330 is accommodated in the puffer guide 50.

A plurality of movable terminal part 330 may be provided. In the illustrated embodiment, the load break switch 1 is provided with three pairs of movable terminal parts 330. The three pairs of movable terminal parts 330 are arranged side by side in the front-rear direction.

The plurality of movable terminal parts 330 may be energizably in contact with or spaced apart from the plurality of fixed terminal parts 320, respectively. That is, the movable terminal part 330 may be rotated to contact the fixed terminal part 320 or may be rotated to be spaced apart from the fixed terminal part 320. The contact and separation may be achieved according to the rotation of the rotation shaft 40 connected to the movable terminal part 330.

When the movable terminal part 330 contacts the fixed terminal part 320 connected to an external power source and a load, energization between an external power source and a load may be applied.

In addition, when the movable terminal part 330 contacts the fixed terminal part 320 connected to a ground wire, the movable terminal part 330 is energizably connected to the ground wire, and energization between the external power source and the load is cut off.

The movable terminal part 330 may be formed of a conductive material. For example, the movable terminal part 330 may be formed of copper, silver, or the like.

In the illustrated embodiment, the movable terminal part 330 includes a movable contact terminal 331 and a movable contact 332.

The movable contact terminal 331 is directly coupled to the rotation shaft 40 and is rotated together with the rotation shaft 40. The movable contact terminal 331 may be rotated clockwise or counterclockwise by the rotation shaft 40.

In an embodiment, the movable contact terminal 331 is arranged such that its central point is the same as the central point of the rotation shaft 40.

The movable contact terminal 331 is formed in a rod shape extending in a predetermined direction. The predetermined direction may be a radial direction of the rotation shaft 40. In an embodiment, the movable terminal part 330 is bent and extended toward the fixed terminal part 320.

In the illustrated embodiment, both ends of the movable contact terminal 331 are divided into two parts in the radial direction of the rotation shaft 40. A movable contact 332 is formed at each end.

The movable contact 332 is energizably connected to the movable contact terminal 331.

The movable contact 332 is in contact with or separated from the fixed contact 321b, 322b. Accordingly, the load break switch 1 may be energized or cut off from an external power source or a load.

The movable contact 332 is located at both ends of the movable contact terminal 331. That is, the movable contact 332 is located radially outward with respect to the rotation shaft 40.

In an embodiment, the movable contact 332 is disposed to be surrounded by the puffer guide 50. In another embodiment, the movable contact 332 is disposed radially more outward from the puffer guide 50 with respect to the rotation shaft 40. That is, in the above embodiment, the movable contact 332 is not surrounded by the puffer guide 50, but is exposed to the outside of the puffer guide 50.

A plurality of movable contacts 332 may be provided. In the illustrated embodiment, two movable contacts 332 are located at both ends of the movable contact terminal 331, respectively. That is, the movable contact terminal 331 includes a total of four movable contacts 332.

When the rotation shaft 40 rotates, the movable contact 332 is rotated together with the rotation shaft 40. The movable contact 332 is accommodated in the inner space of the frame unit 10 to be rotatable with respect to the rotation axis of the rotation shaft 40.

In an embodiment, the movable contact 332 may be integrally formed with the movable contact terminal 331.

### (4) Description of the Rotation Shaft 40

Hereinafter, the rotation shaft 40 will be described with reference to FIGS. 4 to 6.

The rotation shaft 40 is connected to the movable terminal part 330 and rotates together with the movable terminal part 330. By the rotation of the rotation shaft 40, the movable terminal part 330 may be energizably in contact with or spaced apart from the fixed terminal part 320.

The rotation shaft 40 is rotatably coupled to the frame unit 10. Specifically, the rotation shaft 40 is rotatably accommodated in the inner space of the frame unit 10.

The rotation shaft 40 is connected to the movable terminal part 330. In the illustrated embodiment, a plurality of movable terminal parts 330 are through-coupled to the rotation shaft 40.

In addition, the rotation shaft 40 is energizably connected to the movable terminal part 330. Therefore, the electric current flowing into the load break switch 1 through the fixed terminal part 320 may proceed toward the other fixed terminal part 320 through the movable terminal part 330 and the rotation shaft 40.

The puffer guide 50 is coupled to one side of the rotation shaft 40. In an embodiment, the inner space of the puffer guide 50 and the inner space of the rotation shaft 40 communicate with each other.

In addition, the rotation shaft 40 may be connected to a handle (not shown) or an operation unit (not shown). The rotation of the rotation shaft 40 may be manually operated by the handle or automatically operated by the operation unit.

In the illustrated embodiment, the rotation shaft 40 rotates clockwise or counterclockwise with respect to the central axis.

The rotation shaft 40 rotates and rotates the movable terminal part 330. That is, the movable terminal part 330 may be rotated by the rotation shaft 40 in a direction toward the fixed terminal part 320 or away from the fixed terminal part 320.

The rotation shaft 40 is formed in a cylindrical shape. In an embodiment, the central point of the rotation shaft 40 is positioned to be the same as the central point of the movable terminal part 330.

A plurality of rotation shafts 40 may be provided. The number of the rotation shafts 40 is equal to the number of the movable terminal parts 330. In the illustrated embodiment, three rotation shafts 40 are arranged side by side in the front-rear direction.

The number of the rotation shafts 40 may be determined according to the type of power system provided with the load break switch 1 of the present disclosure. When the load break switch 1 is provided in a power system using a three-phase circuit of R, S, and T phases, three rotation shafts 40 may also be provided in accordance with the three-phase circuit.

In the illustrated embodiment, the rotation shaft 40 includes a pillar portion 410 and an uneven portion 420.

The pillar portion 410 forms the exterior of the rotation shaft 40.

The pillar portion 410 is through-coupled to the movable terminal part 330 and rotates together with the movable terminal part 330.

The pillar portion 410 is disposed between two facing puffer guides 50, and is coupled to the two puffer guides 50, respectively.

The pillar portion 410 is formed in a cylindrical shape. In the illustrated embodiment, a hollow is formed in the central portion of the pillar portion 410.

An uneven portion 420 are formed at both ends of the pillar portion 410.

The uneven portion 420 more firmly couples two adjacent rotation shafts 40.

The uneven portion 420 of one of the two adjacent rotation shafts 40 is placed adjacent to the uneven portion 420 of the other rotation shaft 40.

The uneven portions 420 of the two rotation shafts 40 are formed in shapes corresponding to each other. Accordingly, the uneven portions 420 of the two rotation shafts 40 may be engaged and coupled to each other. Accordingly, when one rotation shaft 40 rotates, the remaining rotation shaft 40 may also rotate.

### (5) Description of the Puffer Guide 50

Hereinafter, the puffer guide 50 will be described with reference to FIGS. 4 to 6.

The puffer guide 50 may disperse and extinguish the arc by narrowing the flow path of the gas, whose pressure increases as the movable terminal part 330 rotates.

The puffer guide 50 is accommodated in the inner space of the frame unit 10.

The puffer guide 50 is coupled to one side of the rotation shaft 40. The puffer guide 50 extends radially outward of the rotation shaft 40 from the one side of the rotation shaft 40. In an embodiment, the puffer guide 50 may be coupled to the rotation shaft 40 by welding.

A plurality of puffer guides 50 may be provided. In an embodiment, two puffer guides 50 may be provided. The two puffer guides 50 are disposed to face each other with the rotation shaft 40 interposed therebetween. That is, the two puffer guides 50 are disposed to be point-symmetric with respect to the rotation shaft 40.

The puffer guide 50 is formed to surround the movable terminal part 330. In the above embodiment, one side of the puffer guide 50 facing radially outward of the rotation shaft 40 is open. Accordingly, an arc generated when the movable terminal part 330 rotates may be guided to the arc chute 60.

The puffer guide 50 coupled to the rotation shaft 40 rotates together with the rotation shaft 40 when the rotation shaft 40 rotates. That is, the puffer guide 50 may be rotated clockwise or counterclockwise. At this time, the puffer guide 50 rotates in a direction toward the arc chute 60 or away from the arc chute 60, but does not collide with the arc grid of the arc chute 60.

During the rotation process, the gas inside the arc chamber 310 is compressed and the pressure thereof is increased. The gas passes through the puffer guide 50 and flows in a direction opposite to the rotation. In the flow process, the gas passes through the puffer guide 50 at high speed, and an arc extinguishing operation may be performed.

In the illustrated embodiment, the puffer guide 50 includes a housing part 510 and an insertion part 520.

The housing part 510 forms the exterior of the puffer guide 50.

The housing part 510 supports the movable terminal part 330 in the front, rear, and left and right directions.

The housing part 510 is disposed adjacent to the rotation shaft 40. In addition, the housing part 510 is directly coupled to the rotation shaft 40. In an embodiment, the housing part 510 may be coupled to the rotation shaft 40 by welding.

The housing part 510 is formed in a pillar shape with a hollow formed therein. Both sides of the housing part 510 facing the radial direction of the rotation shaft 40 are open.

In the illustrated embodiment, the housing part 510 may be divided into a housing front part, a housing rear part 511, and a housing side part based on the rotation direction.

The insertion part 520 is coupled to one end of the housing part 510 facing radially outward of the rotation shaft 40.

The insertion part 520 is coupled to the housing part 510 in a sliding manner. The insertion part 520 coupled to the housing part 510 may be prevented from being arbitrarily detached by a locking sill (not shown) formed in the housing part 510.

When the rotation shaft 40 and the housing part 510 are rotated, the insertion part 520 is rotated together with the housing part 510. During the rotation process, the insertion part 520 does not collide with the arc grid of the arc chute 60. That is, the insertion part 520 is disposed to be spaced apart from the arc grid.

In addition, the distance between one end of the insertion part 520 facing radially outward of the rotation shaft 40 and the rotation shaft 40 is formed to be smaller than the distance between one end of the arc grid facing radially inward of the rotation shaft 40 and the rotation shaft 40. That is, the insertion part 520 is disposed radially more inward with respect to the frame unit 10 as compared with the arc grid.

In the illustrated embodiment, the insertion part 520 may be divided into an insertion front part, an insertion rear part 521, and an insertion side part based on the rotation direction.

The insertion rear part 521 is inserted into the housing rear part 511.

The gas inside the frame unit 10 is compressed when the rotation shaft 40 rotates and flows through the insertion rear part 521 with increased pressure.

In an embodiment, a rear recessed portion 521a for narrowing the flow path of the gas may be formed in the insertion rear part 521.

The rear recessed portion 521 a performs a function of dispersing and extinguishing the arc by narrowing the flow path of the gas inside the frame unit 10.

In addition, when the puffer guide 50 rotates, a runner leg 632 of the arc grid and a portion of grid legs 6412 and 6422 to be described later pass through the rear recessed portion 521a. A detailed description thereof will be described later.

The rear recessed portion 521a is formed by being recessed from one side facing radially outward of the rotation shaft 40 in a direction toward the rotation shaft 40.

The rear recessed portion 521a is formed with a predetermined cross-section extending in the thickness direction of the insertion part 520. In an embodiment, the predetermined cross-section is a trapezoid.

### 2. Description of the Arc Chute 60 According to an Exemplary Embodiment of the Present Disclosure

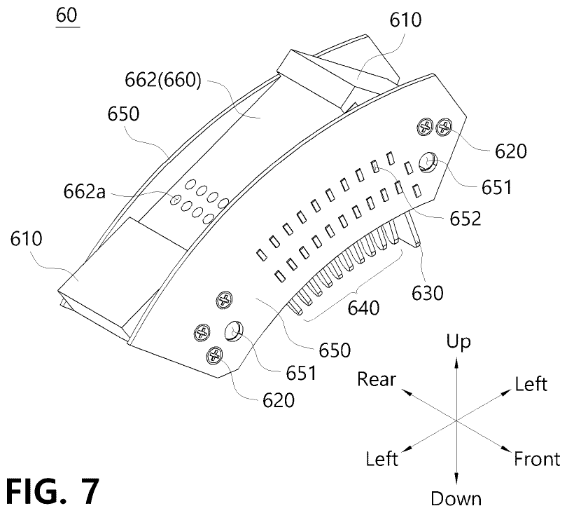

Hereinafter, the arc chute 60 according to an exemplary embodiment of the present disclosure will be described with reference to FIGS. 7 to 16.

The arc chute 60 extends the length of the arc that occurs when the electric current is switched on/off, cooling and extinguishing the arc.

The arc chute 60 is disposed adjacent to the outer circumference of the frame unit 10. Specifically, the arc chute 60 is in close contact with the outer circumference of the frame unit 10.

The arc chute 60 is coupled to the frame unit 10. In this case, the arc chute 60 is coupled to the fastening wing parts 111 and 121 of the frame unit 10. Specifically, the fastening wing parts 111 and 121 are inserted into the fastening groove 612 of the arc chute 60.

In addition, a portion of the arc chute 60 is inserted into and coupled to the inner space of the frame unit 10 and the arc chamber 310.

The arc chute 60 is formed in a shape corresponding to the outer circumference of the frame unit 10. In the illustrated embodiment, the arc chute 60 is formed in a curved shape to correspond to the cylindrical frame unit 10, and is formed to extend along the circumferential direction of the frame unit 10. In the above embodiment, the arc chute 60 may be easily installed in the rotary load break switch 1.

In another embodiment, the radius of curvature of the arc chute 60 may be the same as the radius of curvature of the frame unit 10. Accordingly, the arc chute 60 may be in close contact with the outer circumferential surface of the frame unit 10.

A plurality of arc chutes 60 may be provided. In the illustrated embodiment, two arc chutes 60 are formed as a pair. This is to respond to an arc generated when the movable terminal part 330 in contact with the two fixed contacts 321b and 322b is simultaneously separated from the two fixed contacts 321b and 322b.

In the above embodiment, the two arc chutes 60 facing each other with the rotation shaft 40 interposed between them are arranged to be point-symmetric with respect to the central axis of the rotation shaft 40. Accordingly, the arc extinguishing capability of the arc chute 60 may be maximized.

The arc chute 60 is not limited to the illustrated form and may be variously formed. In an embodiment, three pairs of arc chutes 60 may be provided. In the above embodiment, the three pairs of arc chutes 60 may be arranged side by side in the front-rear direction.

It will be understood that the direction of the coordinate system used in describing the arc chute 60 may be changed according to the installation position of the arc chute 60.

In the illustrated embodiment, the arc chute 60 includes a fastening part 610, a coupling member 620, an arc runner 630, an arc grid part 640, a side cover part 650, and a top cover part 660.

The fastening part 610 is a member to which the arc chute 60 is directly coupled to the frame unit 10.

The fastening part 610 is disposed adjacent to the outer circumference of the frame unit 10. In addition, the fastening part 610 is coupled to the fastening wing parts 111 and 121 of the frame unit 10.

The fastening part 610 overlaps the fastening wing parts 111 and 121 in a predetermined direction. In this case, the predetermined direction is an axial direction of the frame unit 10.

The fastening part 610 is disposed between a plurality of side cover parts 650. In the illustrated embodiment, the fastening part 610 is disposed between two side cover parts 650 and coupled to each side cover part 650. In the above embodiment, the fastening part 610 is disposed so that the front and rear sides thereof are covered by the side cover part 650.

A plurality of fastening parts 610 may be provided. The number of fastening parts 610 is the same as the number of fastening wing parts 111 and 121 of the frame unit 10. In the illustrated embodiment, the arc chute 60 is provided with two fastening parts 610. In the above embodiment, the arc runner 630, the arc grid part 640, and the top cover part 660 are disposed between the two fastening parts 610.

In an embodiment, the fastening part 610 may be provided with a fastening hole 611 communicating with a through hole of the side cover part 650. The fastening hole 611 is through-formed in the axial direction of the frame unit 10.

In the illustrated embodiment, a fastening groove 612 is recessed in the fastening part 610.

The fastening groove 612 is formed to be recessed radially outward of the frame unit 10 from one surface in contact with the outer circumferential surface of the frame unit 10. In addition, the fastening groove 612 is formed to extend in the radial direction of the frame unit 10.

In an embodiment, the fastening groove 612 is formed in a shape corresponding to the fastening wing part 111, 121. This assists in a more robust coupling between the fastening groove 612 and the fastening wing part 111, 121.

The fastening groove 612 is coupled to the fastening wing parts 111 and 121 of the frame unit 10. Specifically, the fastening wing parts 111 and 121 are inserted into and coupled to the fastening groove 612. To this end, it is preferable that the thickness of the fastening groove 612 is greater than the thickness of the fastening wing part 111, 121.

The fastening hole 611 is formed by penetrating the fastening part 610 in a predetermined direction. In addition, the fastening hole 611 is formed through the fastening groove 612. In an embodiment, the predetermined direction is an axial direction of the frame unit 10.

The fastening hole 611 is positioned in a straight line with the cover coupling hole 651 of the side cover part 650 and the fastening wing holes 111a and 121a of the fastening wing parts 111 and 121.

The coupling member 620 passes through the fastening part 610 and the fastening wing part of the frame unit 10, and further strengthens the coupling between the fastening part 610 and the fastening wing part 111, 121. Specifically, the coupling member 620 passes through the fastening hole 611 of the fastening part 610, the cover coupling hole 651 of the side cover part 650, and the fastening wing holes 111a and 121a of the fastening wing parts 111 and 121.

The coupling member 620 is not limited to the illustrated form, and may be formed in various forms. In an embodiment, the coupling member 620 may be coupled to the arc chute 60 and the frame unit 10 by a bolt coupling method.

In addition, the coupling member 620 may be formed of a highly rigid material. For example, the coupling member 620 may be formed of a metal material.

In the illustrated embodiment, the arc runner 630 and the arc grid part 640 are disposed between the two coupling members 620.

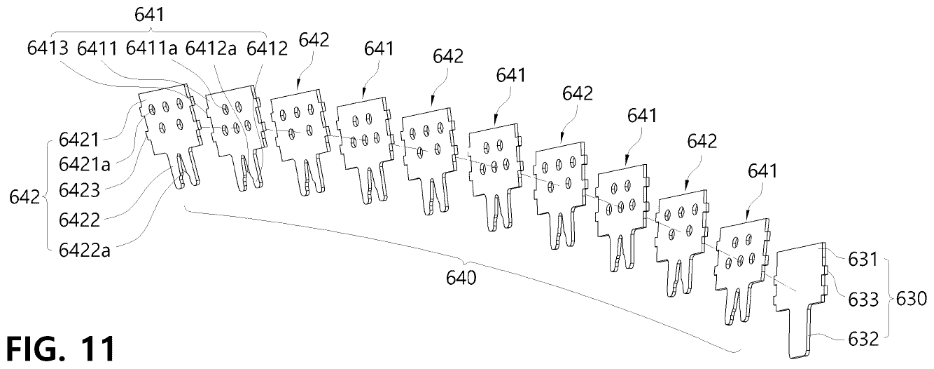

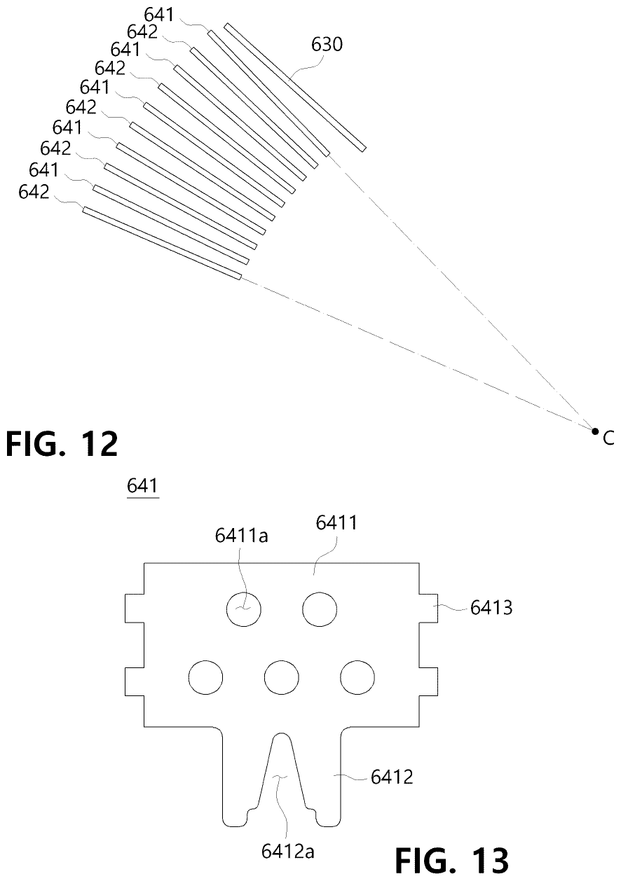

Hereinafter, the arc runner 630 and the arc grid part 640 will be described with reference to FIGS. 11 to 12.

The arc runner 630 may maximize the arc guide effect of the arc chute 60.

The arc runner 630 is disposed between the fixed terminal part 320 and the arc grid part 640. In addition, the arc runner 630 is disposed closer to the fixed terminal part 320 when compared to the arc grid part 640. In the illustrated embodiment, the arc runner 630 is disposed further to the right side with respect to the arc grid part 640.

A portion of the arc runner 630 is in contact with the fixed terminal part 320. Accordingly, when an arc is generated, the arc may be guided toward the arc runner 630. As a result, the arc guide effect can be maximized.

Another portion of the arc runner 630 is inserted into and fixed to the side cover part 650. In this case, the arc runner 630 is disposed between two side cover parts 650 to be coupled to the two side cover parts 650, respectively.

In an embodiment, the arc runner 630 may be formed of a conductive material. For example, the arc runner 630 may be formed of a metal material.

In the illustrated embodiment, the arc runner 630 may be divided into a runner base part 631, a runner leg 632, and a runner coupling protrusion 633.

The runner base part 631 forms a body part of the arc runner 630.

The runner base part 631 is disposed closer to the fixed terminal part 320 when compared to a grid base part 6411, 6421 of the arc grid part 640. In the illustrated embodiment, the runner base part 631 is disposed further to the right side with respect to the grid base part 6411, 6421.

The runner base part 631 is formed in a plate shape. In an embodiment, the runner base part 631 is formed to extend in the width direction. That is, the width of the runner base part 631 is formed to be longer than the length. In the illustrated embodiment, the width direction is the front-rear direction, and the length direction is the up-down direction.

The runner leg 632 is formed on one side of the runner base part 631 facing the fixed terminal part 320. In the illustrated embodiment, the runner leg 632 is formed at the lower side of the runner base part 631.

The runner leg 632 forms an arc-guided path.

The runner leg 632 is disposed adjacent to the fixed terminal part 320. However, when the puffer guide 50 rotates, the runner leg 632 passes through the rear recessed portion 521a of the puffer guide 50 and does not collide with the puffer guide 50.

The runner leg 632 extends from the one side of the runner base part 631 toward the fixed terminal part 320. In addition, the runner leg 632 extends in the length direction. In the illustrated embodiment, the runner leg 632 extends downward from the lower side of the runner base part 631.

In the illustrated embodiment, a portion of the runner leg 632 in contact with the fixed terminal part 320 is bent and extended along the contact surface of the fixed terminal part 320.

In an embodiment, the runner leg 632 may be integrally formed with the runner base part 631.

The runner coupling protrusion 633 is formed on the other side of the runner base part 631 facing the side cover part 650. In the illustrated embodiment, the runner coupling protrusion 633 is formed on the front side and the rear side of the runner base part 631. The runner coupling protrusion 633 fixes the arc runner 630 to the side cover part 650.

The runner coupling protrusion 633 is inserted into the cover through hole 652 of the side cover part 650.

The runner coupling protrusion 633 extends from the other side of the runner base part 631 facing the side cover part 650 toward the side cover part 650. In the illustrated embodiment, the runner coupling protrusion 633 extends from the front side or rear side of the runner base part 631 toward the front side or rear side.

In an embodiment, the runner coupling protrusion 633 may be integrally formed with the runner base part 631.

The arc grid part 640 is arranged on one side of the arc runner 630 opposite to the fixed terminal part 320.

The arc grid part 640 forms an arc-guided path of an arc generated when a current is switched on/off.

The arc grid part 640 is disposed between two side cover parts 650 facing each other. A portion of the arc grid part 640 is inserted into and fixed to the cover through hole 652 of the side cover part 650. That is, the arc grid part 640 is disposed adjacent to the side cover part 650.

In addition, the arc grid part 640 is spaced apart from the fixed terminal part 320.

The arc grid part 640 extends in the radial direction of the frame unit 10. Accordingly, the arc grid part 640 may be adjacent to the movable terminal part 330 that rotates with respect to the central axis of the frame unit 10.

In an embodiment, the arc grid part 640 may be formed of a conductive material. For example, the arc grid may be formed of a metal material.

The arc grid part 640 may include a plurality of arc grids. As the number of arc grids increases, the extension and cooling effects of the arc may increase.

In an embodiment, the arc grid part 640 may be formed by alternately arranging the first arc grid 641 and the second arc grid 642 that are different, at regular intervals.

In the illustrated embodiment, the arc grid part 640 is formed by arranging the first arc grid 641 and the second arc grid 642 that are different, at a constant radius of curvature with respect to a central point C. The central point C is located on the central axis of the frame unit 10 and the rotation shaft 40.

The first arc grid 641 and the second arc grid 642 are formed in a plate shape. In an embodiment, the first arc grid 641 and the second arc grid 642 are formed to be symmetrical with respect to the front-rear direction and left-right direction.

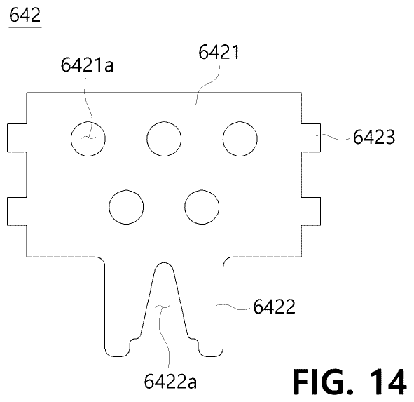

Hereinafter, the first arc grid 641 and the second arc grid 642 will be described with reference to FIGS. 13 to 14.

The first arc grid 641 may be divided into a first grid base part 6411, a first grid leg 6412, and a first grid coupling protrusion 6413.

The first grid base part 6411 forms a body part of the first arc grid 641.

The first grid base part 6411 is formed in a plate shape. In an embodiment, the first grid base part 6411 is formed to extend in the width direction. That is, the width of the first grid base part 6411 is formed to be longer than the length. In the illustrated embodiment, the width direction is the front-rear direction, and the length direction is the up-down direction.

A first grid hole 6411a may be formed through the first grid base part 6411.

The first grid hole 6411a forms a detour path of the arc. Accordingly, the arc can be extended and cooled more efficiently.

A plurality of first grid holes 6411a may be provided. In the illustrated embodiment, five first grid holes 6411a are provided in the first arc grid 641.

The first grid leg 6412 is formed on one side of the first grid base part 6411 facing radially inward of the frame unit 10.

The first grid leg 6412 forms an arc-guided path.

The first grid leg 6412 extends from the one side of the first grid base part 6411 toward the rotation shaft 40. In addition, the first grid leg 6412 extends in the length direction. In the illustrated embodiment, the first grid leg 6412 extends downward from the lower side of the first grid base part 6411.

However, when the puffer guide 50 rotates, the first grid leg 6412 passes through the rear recessed portion 521 a of the puffer guide 50 and does not collide with the puffer guide 50.

The first grid leg 6412 may be formed in various shapes according to the shapes of the movable terminal part 330, the puffer guide 50, etc., and the driving condition of the load break switch 1.

The first grid leg 6412 may be changed in length, shape, and distance to the neighboring second arc grid 642, and etc. according to the driving condition of the load break switch 1.

In the illustrated embodiment, two first grid legs 6412 are provided in the first arc grid 641. In the above embodiment, the first grid leg 6412 is formed to be symmetrical with respect to the front-rear direction and left-right direction of first arc grid 641.

However, the first grid leg 6412 is not limited to the illustrated shape and may be formed in various structures. For example, the first grid leg 6412 may be disposed to be biased in a specific direction with respect to the first arc grid 641.

In an embodiment, the first grid leg 6412 may be integrally formed with the first grid base part 6411.

A first grid concave portion 6412a is formed between the two first grid legs 6412 provided in the first arc grid 641. That is, the first grid concave portion 6412a refers to a space between the two first grid legs 6412.

The first grid concave portion 6412a forms a direct arc-guided path.

The arc generated between the fixed terminal part 320 and the movable terminal part 330 is guided to the first grid concave portion 6412a and extinguished.

The first grid concave portion 6412a may be formed in various shapes. The shape of the first grid concave portion 6412a is determined according to the position and shape of the first grid leg 6412.

In the illustrated embodiment, the first grid concave portion 6412a is formed to be symmetrical with respect to the front-rear direction and left-right direction of first arc grid 641. In an embodiment not shown, the first grid concave portion 6412a may be disposed to be biased in a specific direction with respect to the first arc grid 641.

The first grid coupling protrusion 6413 is formed on the other side of the first grid base part 6411 facing the side cover part 650. In the illustrated embodiment, the first grid coupling protrusion 6413 is formed on the front side and the rear side of the first grid base part 6411.

The first grid coupling protrusion 6413 fixes the first arc grid 641 to the side cover part 650.

The first grid coupling protrusion 6413 is inserted into the cover through hole 652 of the side cover part 650.

The first grid coupling protrusion 6413 is formed to extend from the other side of the first grid base part 6411 toward the side cover part 650. In the illustrated embodiment, the first grid coupling protrusion 6413 extends from the front side or rear side of the first grid base part 6411 toward the front side or rear side.

In an embodiment, the first grid coupling protrusion 6413 may be integrally formed with the first grid base part 6411.

The second arc grid 642 is disposed on one side of the first arc grid 641.

The second arc grid 642 may be divided into a second grid base part 6421, a second grid leg 6422, and a second grid coupling protrusion 6423.

The second grid base part 6421, the second grid leg 6422, and the second grid coupling protrusion 6423 correspond in function and structure to the first grid base part 6411, the first grid leg 6412, and the first grid coupling protrusion 6413 of the first arc grid 641. In addition, a second grid hole 6421a formed in the second grid base part 6421 and a second grid concave portion 6422a formed in the second grid leg 6422 also correspond in function and structure to the first grid hole 6411a and the first grid concave portion 6412a.

However, there is a difference in that the second grid hole 6421a formed in the second grid base part 6421 does not overlap in the arrangement direction of the first grid hole 6411a and the arc grid part 640. That is, grid holes 6411a and 6421a are formed at different portions of the first arc grid 641 and the second arc grid 642.

In addition to this, descriptions overlapping the first arc grid 641 with respect to the second arc grid 642 will be omitted.

However, the shape of the arc grid part 640 is not limited to the above description, and may be formed in various structures capable of extinguishing the arc.

Referring back to FIGS. 7 to 9, the arc runner 630 and the arc grid part 640 are disposed between two side cover parts 650.

The side cover part 650 forms the front side and rear side exterior of the arc chute 60. The side cover part 650 supports the fastening part 610, the arc runner 630, the arc grid part 640, and the top cover part 660 in both directions. In the illustrated embodiment, the side cover part 650 supports the fastening part 610, the arc runner 630, the arc grid part 640, and the top cover part 660 in the front-rear direction.

The side cover part 650 is disposed adjacent to the frame unit 10. Specifically, the side cover part 650 is disposed adjacent to the outer circumference of the frame unit 10 and the fixed terminal accommodation part 112, 122.

A plurality of side cover parts 650 may be provided. In the illustrated embodiment, the arc chute 60 is provided with two side cover parts 650. In the above embodiment, the two side cover parts 650 overlap in the axial direction of the frame unit 10.

The fastening part 610, the arc runner 630, the arc grid part 640, and the top cover part 660 is disposed between the two side cover parts 650 facing each other. In this case, the runner coupling protrusion 633 of the arc runner 630 and the grid coupling protrusion 6413, 6423 of the arc grid part 640 are inserted into the side cover part 650.

That is, the two side cover parts 650 are coupled to both sides of the arc runner 630 and the arc grid part 640, respectively. In an embodiment, the side cover part 650 may be closely coupled to the fastening part 610, the arc runner 630, the arc grid part 640, and the top cover part 660 by the coupling member 620.

In addition, the side cover part 650 is coupled to the outer circumferential surface of the frame unit 10.

In an embodiment, one side of the side cover part 650 in contact with the outer circumference of the frame unit 10 may be formed in a shape corresponding to the outer circumference of the frame unit 10. Accordingly, the one side of the side cover part 650 may be more firmly close contact with the outer circumference of the frame unit 10.

In another embodiment, at least one side of the side cover part 650 may be formed in a curved shape. For example, the side cover part 650 may be formed in a plate shape including a plurality of curves, and may extend in the circumferential direction and radial direction of the frame unit 10.

In the illustrated embodiment, the side cover part 650 is formed in a plate shape that is formed to extend radially outward from a predetermined circular arc. Accordingly, the side cover part 650 may be in close contact with and coupled to the rotary load break switch 1. That is, the side cover part 650 may be easily installed in the rotary load break switch 1.

The one side and the other side of the side cover part 650 are disposed adjacent to the fixed terminal part 320. In the illustrated embodiment, the right side of the side cover part 650 is disposed adjacent to the fixed terminal part 320.

In the illustrated embodiment, a cover coupling hole 651 and a cover through hole 652 are formed in the side cover part 650.

The cover coupling hole 651 is disposed adjacent to the fastening part 610. In an embodiment, the cover coupling hole 651 may communicate with the fastening hole 611 of the fastening part 610. In addition, the cover coupling hole 651 is spaced apart from the arc runner 630 and the arc grid part 640.

The coupling member 620 is through-coupled to the cover coupling hole 651.

A plurality of cover coupling holes 651 may be provided. In an embodiment, the number of cover coupling holes 651 may be the same as the number of coupling members 620.

The cover through hole 652 is formed at a position spaced apart from the cover coupling hole 651.

The arc runner 630 and the arc grid part 640 are inserted into the cover through hole 652. Specifically, the runner coupling protrusion 633 of the arc runner 630 and the grid coupling protrusion 6413, 6323 of the arc grid part 640 are inserted into the cover through hole 652.

A plurality of cover through holes 652 may be provided. The number of cover through holes 652 is equal to the sum of the number of runner coupling protrusions 633 and the number of grid coupling protrusions 6413, 6423 provided in the arc chute 60.

In the illustrated embodiment, a plurality of cover through holes 652 are arranged at regular intervals along a predetermined curve. In the above embodiment, the radius of curvature of the predetermined curve may be the same as the radius of curvature of the frame unit 10.

The cover through hole 652 is formed in a shape corresponding to the runner coupling protrusion 633 and the grid coupling protrusion. In the illustrated embodiment, the cover through hole 652 is formed by extending a rectangular cross-section in the front-rear direction.

The top cover part 660 is inserted between the two side cover parts 650 facing each other.

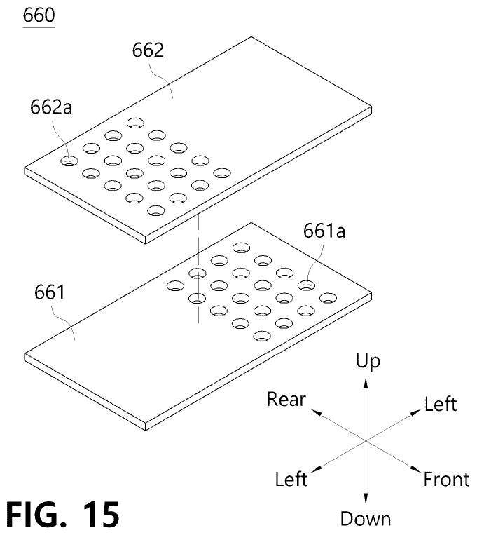

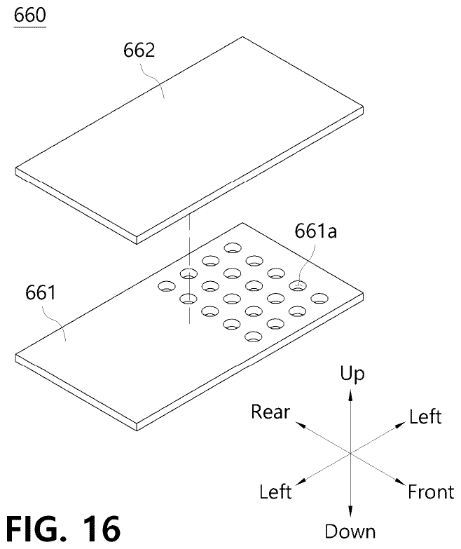

Hereinafter, the top cover part 660 will be described with reference to FIGS. 15 to 16.

The top cover part 660 forms the upper exterior of the arc chute 60.

The top cover part 660 is disposed between two side cover parts 650 to be coupled to the two side cover parts 650, respectively. In this case, the top cover part 660 crosses both ends of the side cover part 650 and blocks the upper opening of the side cover part 650. Accordingly, the top cover part 660 may block the inside and the outside of the arc chamber 310.

Accordingly, the discharge of flying debris and high-temperature gas generated inside the arc chamber 310 during arc generation can be blocked by the top cover part 660. Furthermore, insulation breakdown due to the flying debris and high-temperature gas discharged to the outside of the arc chute 60 can be prevented. As a result, firing outside the arc chute 60 can be blocked.

In addition, the top cover part 660 can block one side of the space between two adjacent arc grids 641 and 642, so that the arc voltage inside the arc chute 60 can be kept constant regardless of the passage of time. Accordingly, the arc extinguishing performance of the arc chute 60 can be further improved.

The top cover part 660 is spaced apart from the outer circumferential surface of the frame unit 10. Specifically, the top cover part 660 is disposed with the outer circumferential surface of the frame unit 10 and the arc grid part 640 interposed therebetween.

In an embodiment, the top cover part 660 may be formed of a flat plate extending in one direction. In the above embodiment, the top cover part 660 is formed in a plate shape crossing both ends of the two side cover parts 650.

In another embodiment, the top cover part 660 may be formed of a curved plate corresponding to the curve of the side cover part 650.

In the illustrated embodiment, top cover holes 661a and 662a are formed in a portion of the top cover part 660. However, the top cover part 660 is not limited to the illustrated structure, and may be formed in various structures. For example, the top cover part 660 may be formed to seal the upper side of the side cover part 650.

At least a portion of the top cover part 660 may be formed of an N-9 (nylon-9) material. In an embodiment, one surface of the top cover part 660 facing the arc grid part 640 may be formed of an N-9 material.

The N-9 material is a polyamide Pa6/Pa66 series, and when directly exposed to the arc, it emits hydrogen gas with excellent thermal conductivity. Accordingly, the top cover part 660 generates hydrogen gas when directly exposed to the arc and can increase the arc extinguishing cooling effect.

A plurality of top cover parts 660 may be provided.

In the illustrated embodiment, the top cover part 660 includes a first top cover 661 and a second top cover 662.

The first top cover 661 is disposed adjacent to the arc grid part 640 to preferentially block the arc passing through the arc chute 60. In the illustrated embodiment, the first top cover 661 is disposed above the arc grid part 640.

In an embodiment, one surface of the first top cover 661 facing the arc grid part 640 may be formed of an N-9 material.

The first top cover 661 crosses both ends of the side cover part 650 and blocks the upper opening of the side cover part 650. In addition, the first top cover 661 is spaced apart from the outer circumferential surface of the frame unit 10.

In the illustrated embodiment, the first top cover 661 is formed in a quadrangular flat plate shape. However, the first top cover 661 is not limited to the illustrated shape, and may be formed in various shapes. For example, the first top cover 661 may be formed of a curved plate corresponding to the curve of the side cover part 650.

A first top cover hole 661a may be formed through a portion of the first top cover 661.

The first top cover hole 661a forms a detour path of the arc toward the first top cover 661. Accordingly, the arc can be extended and cooled more efficiently.

A plurality of first top cover holes 661a may be provided.

In the illustrated embodiment, the first top cover hole 661a is formed as a circular hole and is formed at a position biased to the right with respect to the central portion of the first top cover 661. This is formed in consideration of the flow direction of air compressed by the puffer guide 50.

However, the first top cover hole 661a is not limited to the illustrated shape and position, and may be formed in various structures capable of forming a detour path of the arc. For example, the first top cover hole 661a may be formed as a quadrangular hole and disposed in the central portion of the first top cover 661.

The second top cover 662 is disposed above the first top cover 661.

The second top cover 662 secondarily blocks the flying debris and the high-temperature gas that have passed through the first cover hole of the first top cover 661. Through this, the emission of flying debris and high-temperature gas generated when an arc is generated may be prevented doubly.

The second top cover 662 is disposed with the arc grid part 640 and the first top cover 661 interposed therebetween. In this case, the second top cover 662 is positioned radially outward of the frame unit 10 with respect to the first top cover 661. In addition, the second top cover 662 is spaced apart from the first top cover 661 at a predetermined interval.

The second top cover 662 crosses both ends of the side cover part 650 and blocks the upper space of the first top cover 661.

The second top cover 662 may be formed in a shape corresponding to that of the first top cover 661. In the illustrated embodiment, the second top cover 662 is formed in a quadrangular flat plate shape. However, the second top cover 662 is not limited to the illustrated embodiment, and may be formed in various shapes. For example, the second top cover 662 may be formed of a curved plate corresponding to the curve of the side cover part 650.

In the embodiment shown in FIG. 15, a second top cover hole 662a is formed through a portion of the second top cover 662.

The second top cover hole 662a forms a detour path of the arc toward the second top cover 662. Accordingly, the arc can be extended and cooled more efficiently.

A plurality of second top cover holes 662a may be provided.

The second top cover hole 662a is disposed so as not to overlap each other in the arrangement direction of the first top cover hole 661a, the first top cover 661, and the second top cover 662. In the illustrated embodiment, the second top cover hole 662a is formed as a circular hole and is formed at a position biased to the left with respect to the central portion of the second top cover 662.

However, the second top cover hole 662a is not limited to the illustrated shape and position, and may be formed in various structures capable of forming a detour path of the arc. For example, the second top cover hole 662a may be formed as a quadrangular hole and disposed in the central portion of the second top cover 662.

In the embodiment illustrated in FIG. 16, the second top cover 662 may be formed to seal the upper space of the first top cover 661 by omitting the second top cover hole 662a. Accordingly, the upper side of the side cover part 650 may be sealed.

In the above embodiment, the arc, flying debris, high-temperature gas, and the like that have passed through the first top cover hole 661a collide with the second top cover 662 and are not discharged to the outside of the arc chute 60.

### 3. Description of the Arc Chute 60 According to Another Embodiment of the Present Disclosure

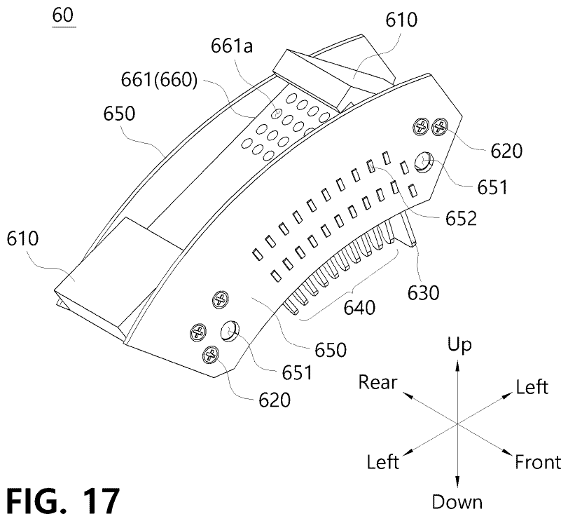

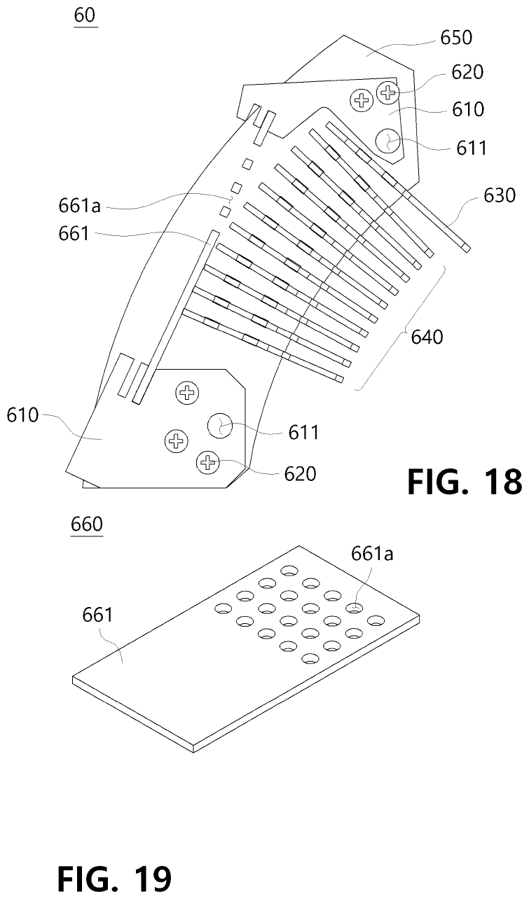

Hereinafter, the arc chute 60 according to another embodiment of the present disclosure will be described with reference to FIGS. 17 to 20.

The arc chute 60 according to the present embodiment includes a fastening part 610, a coupling member 620, an arc runner 630, an arc grid part 640, a side cover part 650, and a top cover part 660.

Among the above components, the fastening part 610, the coupling member 620, the arc runner 630, the arc grid part 640, and the side cover part 650 correspond in function and structure to the fastening part 610, the coupling member 620, the arc runner 630, the arc grid part 640, and the side cover part 650 according to the above-described embodiment.

However, the top cover part 660 according to the present embodiment is different from the top cover part 660 according to the above-described embodiment in some components. Specifically, the top cover part 660 according to the present embodiment is different from the top cover part 660 according to the above-described embodiment in that a single top cover part 660 is provided in the arc chute 60.

Hereinafter, the top cover part 660 according to the present embodiment will be described focusing on differences from the top cover part 660 according to the above-described embodiment.

The top cover part 660 includes a first top cover 661.

As described above, the first top cover 661 is disposed adjacent to the arc grid part 640 to preferentially block the arc passing through the arc chute 60.

In the embodiment shown in FIG. 19, a first top cover hole 661a is formed through a portion of the first top cover 661. In this case, the first top cover hole 661a has the same structure and function as the first top cover hole 661a according to the above-described embodiment.

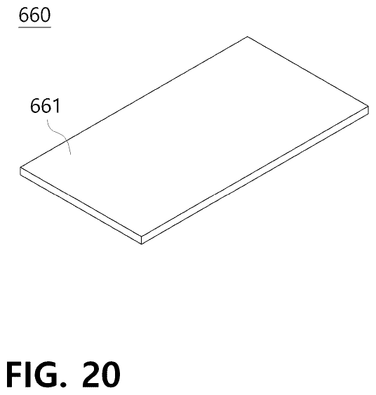

In the embodiment illustrated in FIG. 20, the first top cover 661 may be formed to seal the upper side of the side cover part 650 by omitting the first top cover hole 661a. In the above embodiment, the arc, flying debris, high-temperature gas, and the like that have passed through the arc grid part 640 collide with the first top cover 661 and are not discharged to the outside of the arc chute 60.

4. Description of a Process in which an Arc Extinguishing Operation is Performed in the Arc Chute 60 According to an Exemplary Embodiment of the Present Disclosure

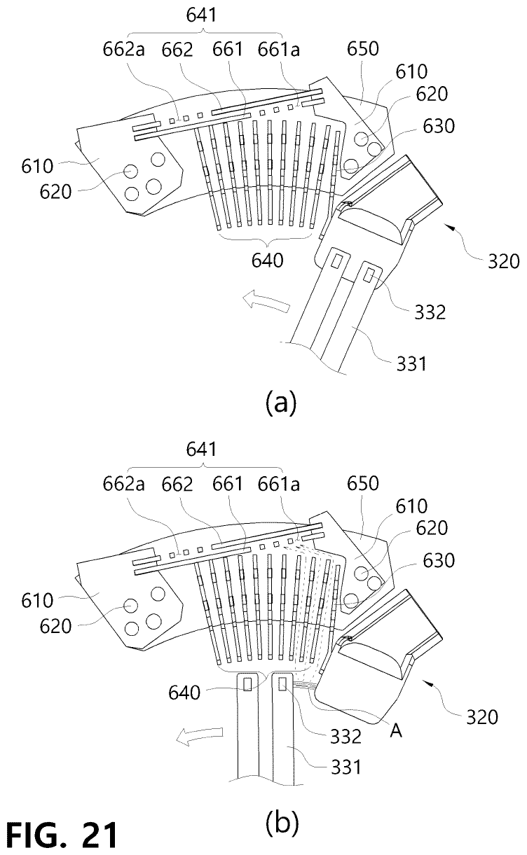

Hereinafter, an arc extinguishing operation of the arc chute 60 according to an exemplary embodiment of the present disclosure will be described with reference to FIG. 21. The direction of rotation of each component will be understood with reference to FIG. 21.

FIG. 21 (a) shows the load break switch 1 before an arc A is generated, and FIG. 21 (b) shows the load break switch 1 after an arc A is generated.

When the movable contact 332 rotates in a direction away from the fixed contacts 321b and 322b, the movable contact 332 and the fixed contacts 321b and 322b are separated from each other, and an arc A is generated.

The generated arc A is primarily guided toward the arc runner 630. The arc A guided toward the arc runner 630 is moved from the arc runner 630 toward the arc grid part 640. Specifically, the arc A is moved toward the grid concave portions 6412a and 6422a of the arc grid part 640.

The arc A is moved along the grid concave portions 6412a and 6422a provided in the plurality of arc grid parts 640 in a direction away from the fixed terminal part 320.

In the above process, some of the arc A, the flying debris, and the high-temperature gas may flow radially outward of the frame unit 10 through the arc grid part 640. At this time, the arc A, the flying debris, and the high-temperature gas flowing radially outward of the frame unit 10 collide with the top cover part 660.

In the illustrated embodiment, the arc A, the flying debris, and the high temperature gas flowing upward of the arc grid part 640 first collide with the first top cover 661.

Some of the arc A, the flying debris, and the high-temperature gas flowing toward the first top cover 661 flow through the first top cover hole 661a toward the second top cover 662. Some of the arc A, the flying debris, and the high temperature gas flowing toward the second top cover 662 collide with the second top cover 662, and only the remaining part passes through the second top cover hole 662a.

In summary, the arc A, the flying debris, and the high-temperature gas flowing upward of the arc grid part 640 sequentially pass through the first top cover 661 and the second top cover 662. In this case, the first top cover hole 661a and the second top cover hole 662a do not overlap each other in the arrangement direction of the first top cover 661 and the second top cover 662.

Accordingly, the amount of discharge of the arc A, the flying debris, and the high temperature gas may be sequentially reduced in the process of passing through the first top cover 661 and the second top cover 662. In addition, as a detour path of the arc A is formed, the arc A can be extended and cooled and extinguished as the aforementioned series of processes progress.

Although the present disclosure has been described above with reference to preferred exemplary embodiments thereof, the present disclosure is not limited to the configurations of the above-described embodiments.

In addition, the present disclosure may be variously modified and changed without departing from the idea and scope of the present disclosure described in the following claims by those skilled in the art to which the present disclosure pertains.

Furthermore, the embodiments may be configured by selectively combining all or some of the embodiments so that various modifications may be made thereto.

### DESCRIPTION OF SYMBOLS

1: load break switch
10: frame unit
110: upper frame
111: upper fastening wing part
111a: upper fastening wing hole
112: upper fixed terminal accommodation part
120: lower frame
121: lower fastening wing part
121a: lower fastening wing hole
122: lower fixed terminal accommodation part
20: fixing part
210: fixing plate
211: fixing hole
220: support fixture
30: switch unit
310: arc chamber
320: fixed terminal part
321: first fixed terminal part
321a: first fixed contact terminal
321b: first fixed contact
322: second fixed terminal part
322a: second fixed contact terminal
322b: second fixed contact
330: movable terminal part
331: movable contact terminal
332: movable contact
40: rotation shaft
410: pillar portion
420: uneven portion
50: puffer guide
510: housing part
511: housing rear part
520: insertion part
521: insertion rear part
521a: rear recessed portion
60: arc chute
610: fastening part
611: fastening hole
612: fastening groove
620: coupling member
630: arc runner
631: runner base part
632: runner leg
633: runner coupling protrusion
640: arc grid part
641: first arc grid
6411: first grid base part
6411a: first grid hole
6412: first grid leg
6412a: first grid concave portion
6413: first grid coupling protrusion
642: second arc grid
6421: second grid base part
6421a: second grid hole
6422: second grid leg
6422a: second grid concave portion
6423: second grid coupling protrusion
650: side cover part
651: cover coupling hole
652: cover through hole
660: top cover part
661: first top cover
661a: first top cover hole
662: second top cover
662a: second top cover hole

1. An arc chute, comprising:
an arc grid part;
two side cover parts spaced apart from each other and overlapping in one direction, and respectively coupled to both sides of the arc grid part; and
a top cover part that is disposed between the two side cover parts and coupled to each of the two side cover parts, and is formed in a plate shape extending across both ends of the two side cover parts.

2. The arc chute of claim 1, wherein the top cover part has a top cover hole formed through a portion thereof.

3. The arc chute of claim 2, wherein the top cover part comprises a plurality of top cover holes.

4. The arc chute of claim 1, wherein the top cover part is formed to seal one side of the side cover part.

5. The arc chute of claim 1,
wherein the top cover part comprises:
a first top cover adjacent to the arc grid part; and
a second top cover spaced apart from the first top cover and placed with the arc grid part and the first top cover interposed therebetween.

6. The arc chute of claim 5, wherein the first top cover has a first top cover hole formed through a portion thereof.

7. The arc chute of claim 6, wherein the second top cover has a second top cover hole formed through a portion thereof.

8. The arc chute of claim 7, wherein the first top cover hole and the second top cover hole do not overlap each other in the arrangement direction of the first top cover and the second top cover.

9. The arc chute of claim 1, wherein the top cover part is formed of a flat plate extending in one direction.

10. The arc chute of claim 1,
wherein at least one side of the side cover part is formed in a curved shape, and
the top cover part is formed of a curved plate corresponding to the curve of the side cover part.

11. The arc chute of claim 1, wherein at least a portion of the top cover part is formed of an N-9 (nylon-9) material.

12. The arc chute of claim 11, wherein one surface of the top cover part facing the arc grid part is formed of an N-9 material.

13. The arc chute of claim 1, wherein the arc grid part has a grid hole formed through a portion thereof.

14. The arc chute of claim 13, wherein the arc grid part is formed by alternately arranging two arc grids in which the grid holes are formed at different parts.

15. A load break switch, comprising:
a switch unit comprising a fixed terminal part and a movable terminal part;
a frame unit accommodating a portion of the fixed terminal part;
a rotation shaft rotatably coupled to the frame unit and connected to the movable terminal part to rotate together with the movable terminal part; and
an arc chute placed adjacent to the fixed terminal part,
wherein the arc chute comprises:
an arc grid part;
two side cover parts spaced apart from each other, overlapping in one direction, respectively coupled to both sides of the arc grid part, and respectively coupled to an outer circumferential surface of the frame unit; and
a top cover part that is disposed between the two side cover parts, coupled to each of the two side cover parts, spaced apart from the outer circumferential surface of the frame unit, and is formed in a plate shape extending across both ends of the two side cover parts.

16. The load break switch of claim 15, wherein the top cover part has a top cover hole formed at a position which is biased toward the fixed terminal part adjacent with respect to the central portion.

17. The load break switch of claim 15,
wherein the arc chute comprises:
an arc runner placed between the two side cover parts, coupled to the two side cover parts, respectively, placed between the fixed terminal part and the arc grid part, with a portion thereof in contact with the fixed terminal part.

18. The load break switch of claim 15,
wherein the top cover part comprises:
a first top cover adjacent to the arc grid part; and
a second top cover spaced apart from the first top cover and positioned radially outward of the frame unit with respect to the first top cover.

19. The load break switch of claim 18, wherein the first top cover has a first top cover hole formed at a position which is biased toward the fixed terminal part adjacent with respect to the central portion.

20. The load break switch of claim 15,
wherein the top cover part is formed of a flat plate extending in one direction.
